(19) United States
(12) Patent Application Publication
(10) Pub. No.: US 2008/0179779 A1
(43) Pub. Date: Jul. 31, 2008

(54) Process For Producing Chopped Rock Fibers

(75) Inventors: Viktor F. Kibol, Kiev (UA); Roman V. Kibol, Kiev (UA)

Correspondence Address: FELLERS, SNIDER, BLANKENSHIP, BAILEY & TIPPENS, PC, 100 NORTH BROADWAY, SUITE 1700, OKLAHOMA CITY, OK, 73102-8820, US

(73) Assignee: Rock Fiber Technology, Inc., Reno, NV (US)

(21) Appl. No.: 11/911,717

(22) PCT Filed: Sep. 15, 2006
(86) PCT No.: PCT/US06/35917

§ 371 Date: Oct. 16, 2007

Related U.S. Application Data
(60) Provisional application No. 60/762,268, filed on Jan. 26, 2006.

(51) Int. Cl. B28B 11/14

(52) U.S. Cl. 264/145; 425/66

(57) ABSTRACT

Method and apparatus for producing chopped rock fibers, such as basalt. A furnace is preferably used to melt rocks, and a drawing assembly is used to draw the melted rocks into fibers. Prior to chopping the fibers to selected lengths, a preconditioning assembly operates to induce mechanical defects in the drawn fibers. Preferably, the preconditioning assembly comprises a shock cooling stage and/or a fiber twisting stage. The shock cooling stage significantly reduces the temperature of the drawn fibers, such as by the application of a stream of fluid such as water or steam to the drawn fibers. Additionally or alternatively, the shock cooling stage preferably comprises a liquid coolant bath through which the drawn fibers pass. The fiber twisting stage preferably utilizes a twisting assembly such as a roller to induce a torsional force upon the drawn fibers to continuously twist the fibers about an axis thereof.

### FIELD OF THE INVENTION

The present invention relates to the field of producing chopped fibers from rocks, and more particularly but not by way of limitation, to improved methods and arrangements for producing chopped basalt fibers.

### BACKGROUND

It has long been known that ecologically safe materials can be produced from various kinds of rocks, and that such materials have been found to be acceptable substitutes for asbestos, glass, metal, wood, and the like. There is a continuing demand for chopped fibers made of basalt and other raw material rocks to be used for the making of thermal and noise insulation and for fillings for certain composite materials, such as construction materials.

One prior art process for producing continuous fiber from rock materials generally includes steps of rock fragmentation, passing the fragmented (crushed) rocks to a melting furnace, heating the rocks to a molten stage, homogenizing the melt, stabilizing the melt in a melting furnace feeder, drawing the melt into fiber, and chopping the fiber into segments. This process is described, for example, in Continuous Glass Fiber. Ed., M. G. Chernyak. Moscow: “Khimiya” [Chemistry], 1965.

In this process, the coil or raw thread from winding frames is fed to a cutting device for segmenting the fibers, following which the segmented threads are air blown to break and separate the segments into chopped fibers. One limitation with this process is that the cutting device consumes a relatively large amount of energy.

USSR Inventor's Certificate No. 1308578 (IPC 4 C03 B 37/16, Pub. Jul. 5, 1987, Bul. 17) generally discloses a two-stage method for chopping rock fibers which includes a preliminary step of fiber notching on a hard surface, followed by cutting the fibers on an elastic roller to achieve reduced stress on the cutting apparatus. However, this method is also energy intensive as it involves two operations at the chopped fiber production stage (the notching and chopping steps).

Another known fiber chopping arrangement generally utilizes a base structure that supports a fiber feeding mechanism and a cutting apparatus with pairs of counter-rotating, offset cutter head/pressure rollers. A cutter gap is formed between each pair of such rollers, and the fibers pass through the cutter gaps. A rigid plate can be juxtapositioned so that partial chopping of the fibers is achieved by the cutter head engaging the fibers against the rigid plate prior to the fibers passing through the cutter gaps. See USSR Inventor's Certificate No. 1308578, IPC 4 C03 B 37/16, Pub. Jul. 5, 1987, Bul. 17. This is also very energy intensive, as two drives are normally used at the fiber chopping stage, one to rotate the cutter head and one to rotate the pressure roller.

There is accordingly a continued need for improvements that overcome these and other limitations of the prior art, and it is to such improvements that preferred embodiments of the present invention are generally directed.

### SUMMARY OF THE INVENTION

Preferred embodiments of the present invention are generally directed to an apparatus and method for producing chopped rock fibers, such as from basalt.

In accordance with preferred embodiments, a furnace is preferably used to melt rocks, and a drawing assembly is used to draw the melted rocks into fibers. Prior to chopping the fibers to selected lengths, a preconditioning assembly operates to induce mechanical defects in the drawn fibers.

Preferably, the preconditioning assembly comprises a shock cooling stage and/or a fiber twisting stage. The shock cooling stage significantly reduces the temperature of the drawn fibers, such as by the application of a stream of fluid such as water or steam to the drawn fibers. Additionally or alternatively, the shock cooling stage uses a liquid coolant bath through which the drawn fibers pass.

The fiber twisting stage preferably utilizes a twisting assembly, such as a roller, to induce a torsional force upon the drawn fibers to continuously twist the fibers about an axis thereof.

In this way, mechanical defects are selectively induced in the drawn fibers, which advantageously reduces the energy requirements of the chopping process.

Other features and advantages of preferred embodiments of the present invention will become apparent from the following description when read in conjunction with the accompanying drawings and appended claims.

### BRIEF DESCRIPTION OF THE DRAWINGS

FIG. 1 schematically illustrates the arrangement for chopped basalt fiber production in accordance with preferred embodiments of the present invention.

FIG. 2 is schematic representation of the arrangement of FIG. 1 with particular reference to that view taken at A-A therein with further detailing of the basalt fiber cutting means.

FIG. 3 is a table of results achieved by various preferred embodiments of the present invention.

### DETAILED DESCRIPTION

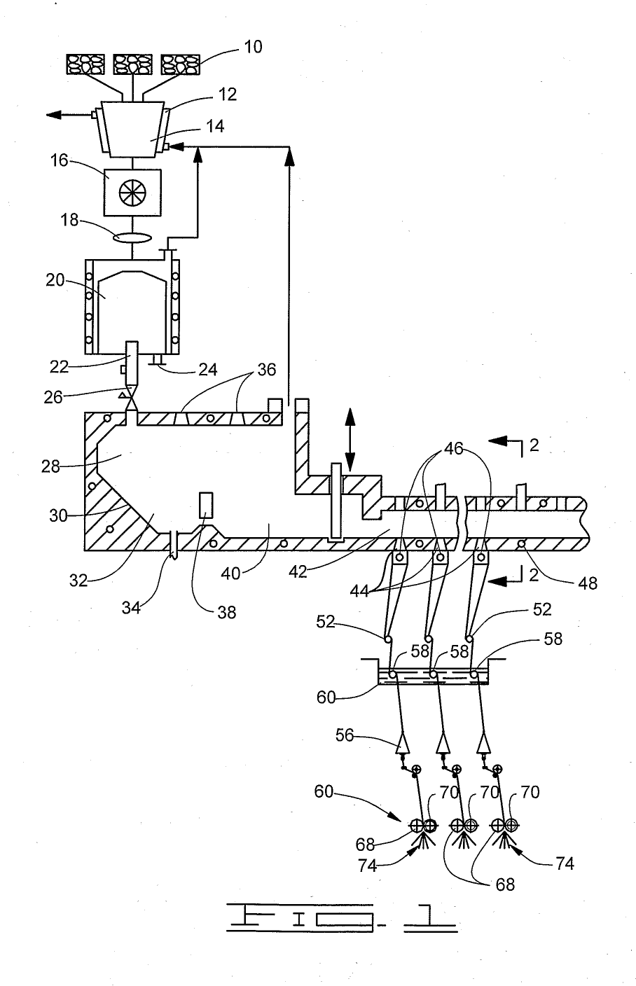

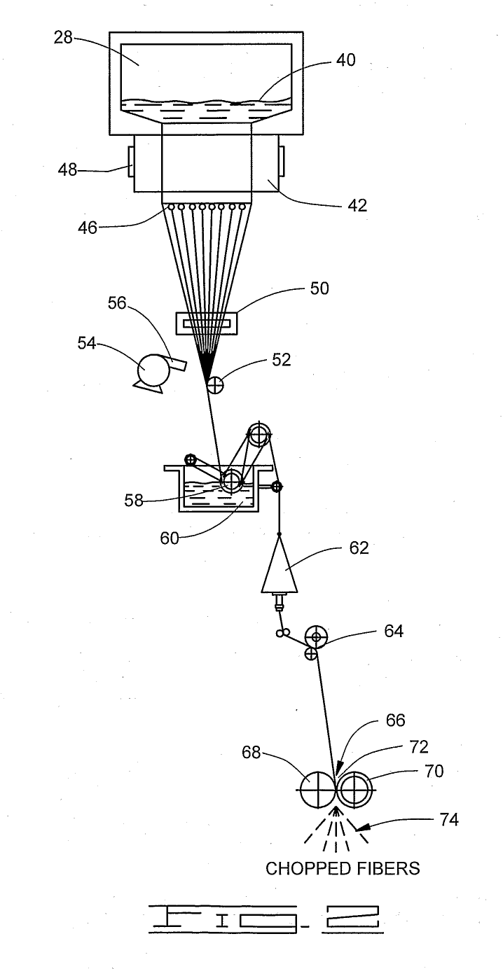

Referring to FIGS. 1 and 2, an arrangement for the production of basalt fibers in accordance with preferred embodiments of the present invention comprises bins 10 that are used to store crushed or fragmented rock material. This fragmented rock material, serving as the starting materials for the process described herein, passes from the bins 10 to a heat exchanger 12 and a dosing unit 14. From the dosing unit 14 the rock material passes to a mechano-catalytic activator 16, the output of which passes to a mineral loader 18. The mineral loader 18 feeds the rock material to a melting furnace 20 that has a draining means 22 and a drain fitting 24.

The draining means 22 has an adjustable cut-off valve 26 for feeding the melt into a horizontal equalizing chamber 28. The equalizing chamber 28 has an inclined plane or plate surface 30, an accumulator bath 32 with built-in barbotage nozzles 34, burners 36 for heating the melt, an anti-foam dam or weir 38, a melt-stabilizing pool 40, a feeder 42, drawing assemblies 44 and draw orifices with plate valves 46 through which the continuous fibers are drawn. (It is noted that continuous fibers are sometimes referred to in the fiber industry as CF).

The drawing assemblies 44, feeder 42 and equalizing chamber 28 are provided with a heating system 48, and the heat exchanger 12 is connected with the melting furnace 20 and with the horizontal equalizing chamber 28.

The fibers pass though a lubricating assembly 50 from which they are gathered and pulled by a roller 52 to a shock cooling stage. Preferably, the shock cooling stage includes a compressor 54 having a nozzle 56 which directs a cooling fluidic stream against the fibers, such as a stream of air. A liquid-immersed roller 58 next preferably pulls the cooled fibers into a liquid coolant bath 60. The liquid of the bath 60 preferably comprises water, although other suitable coolants can be alternatively utilized as desired such as a calcium oxide saturated solution From the liquid bath 58 the fibers are passed through a rotating hollow spindle 62 to receiving rolls 64. Preferably, the spindle 62 operates as a fiber twisting stage and includes a corresponding channel which applies a torsional force upon the fibers as the fibers pass therethrough. This torsional force induces a continuous twisting, or rotational displacement, of the fibers along the length thereof.

The rolls 64 direct the fibers to a basal chopping assembly 66, which comprises pairs of mated cutting heads 68 and pressure rollers 70. A cutting gap 72 is defined between each cutting head 68 and pressure roller 70 pair. The cutter heads 68 and pressure rollers 70 counter rotate, thereby gripping and pulling the fibers through the cutting gaps 72 where the fibers are cut into segments to form the chopped fibers 74.

At this point it will be appreciated that the shock cooling stage and, when utilized, the twisting stage operate to precondition the fibers by inducing mechanical stress therein prior to the chopping stage. This has been found to significantly reduce the energy required to subsequently chop the fibers into the desired lengths.

In an alternative preferred embodiment, the shock cooling stage utilizes the compressor 54 and nozzle 56 to direct the cooling fluid against the hot fibers without the subsequent use of the roller 58 and liquid coolant bath 60. Any suitable coolant fluid can be utilized, such as but not limited to air, steam, or a vaporous surfactant such as a surface alkali vapor.

In another preferred embodiment, the hot fibers are passed through the liquid coolant bath 60 without the prior application of the fluidic stream thereto. Any suitable liquid can be utilized in the bath including but not limited to water, sea water or a calcium oxide saturated solution.

In another alternative preferred embodiment, the shock cooling stage is not utilized so that the preconditioning step comprises just the twisting of the heated fibers such as by means of the fiber twisting spindle 62. It is contemplated that the particular preconditioning methodology utilized in a given application will be selected in accordance with the requirements thereof. Reasons that each of these various preconditioning approaches, individually or in combination, serves to reduce the energy requirements of the chopping process will now be discussed more fully.

The strength of rock fibers is generally a function of the defects present both in the material volume and on the fiber surface. It has been found that surface defects generally have a greater adverse impact on the overall strength of the fibers. Thus, creating defects of the fiber surface causes significant decrease in the fiber strength, facilitating the chopping of the fibers as less cutting force is necessary to chop the fibers.

Also, the application of moisture or surfactants aqueous solution adsorption on the fiber surface can facilitate micro-crack development, which can result in fiber strength reduction such as from about 15 to 30 percent. The fibers, which are preferably drawn at from about 1230° to 1400° C., therefore, at the moment of shock cooling with air, vapors or liquid at about 18° to 20° C., significant thermal stresses are developed within the fiber material, resulting in micro-cracks at the fiber surface. These micro-cracks are stress concentrators, and twisting the fibers leads to their destruction. A processed fiber is preferably twisted 1-1.5 turns around its axis, and the fibers are subjected to a stretching force during cutting.

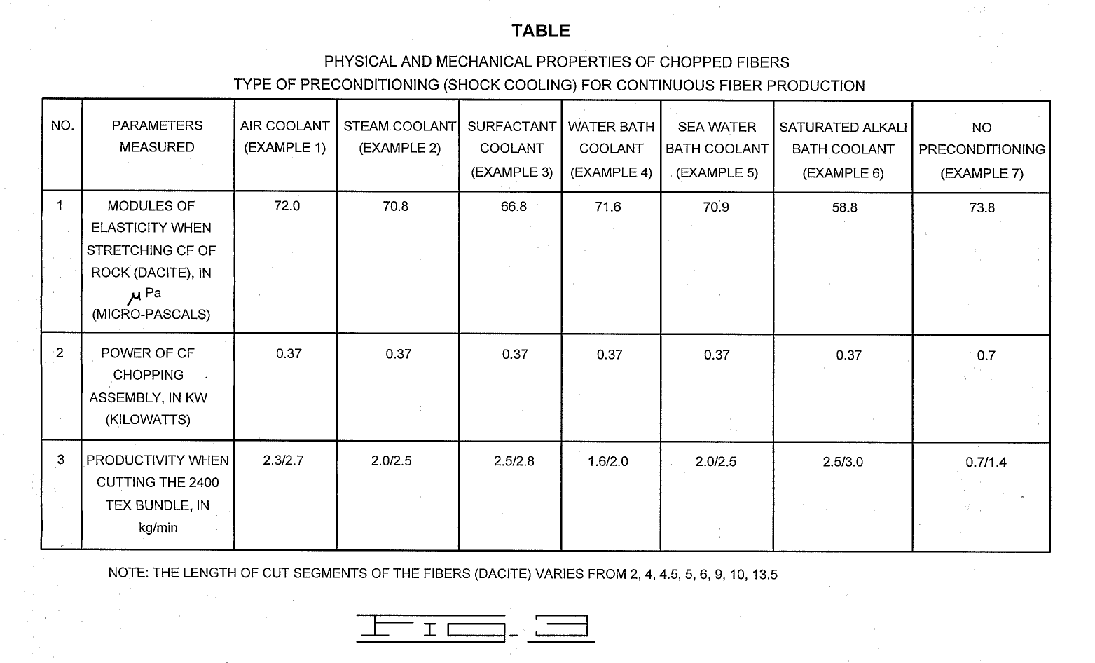

Further details concerning the various alternative preferred embodiments can be understood by the following examples, the results of which are tabulated in FIG. 3. It will be appreciated that these examples are illustrative and not limiting to the scope of the claimed subject matter.

### EXAMPLE 1

Continuous fiber (CF) was produced using dacite (D) lava rocks generally in accordance with the process described herein and illustrated by the drawing figures. Prior to loading the dacite rocks into the melting furnace 20, the dacite was heated to about 810° C. and maintained at this temperature for about 10 minutes. This was performed to remove chemically bound water and to burn off any organic components.

The dacite raw material was next loaded into disintegrator 16, which reduced the material to about 15 μm in size. The material was fed gradually by the loader 18 into the furnace 20 where it was heated to about 2150° C. to about a 96 percent amorphous melt. The melt was fed to the horizontal equalizing chamber 28 and feeder 42 at between about 1420° to about 1710° C., after which the melt was fed to the drawing assembly 44 installed over orifices 46, through which the fibers were drawn.

The hot fibers were then subjected to a preconditioning step of shock cooling by directing a stream of air at about 18° C. from the nozzle 56. The preconditioned fibers were fed to fiber twisting spindle 62 where the fibers were twisted under mechanical stress of twisting with fiber stretching. The twisted fibers were passed to the basalt fiber cutting assembly 66 where chopping was performed in the cutting gap 72 between the cutter head 68 and pressure roll 70.

### EXAMPLE 2

In this example, all operations were performed in a manner similar to Example 1, but at the shock cooling stage a stream of steam was directed against the fibers.

### EXAMPLE 3

In this example, all operations were performed in a manner similar to Example 1, but at the shock cooling stage a stream of vaporous surfactant of calcium oxide saturated vapors at a temperature of about 18° C. was directed against the fibers by the compressor and nozzle 54, 56.

### EXAMPLE 4

In this example, all operations were performed in a manner similar to Example 1, but at the shock cooling stage the fibers were passed through the coolant bath 60 that was filled with water cooled to a temperature of about 18° C.

### EXAMPLE 5

In this example, all operations were performed in a manner similar to Example 3, but at the shock cooling stage the fibers were passed through the coolant bath 60 that was filled with sea water at a temperature of about 18° C.

### EXAMPLE 6

In this example, all operations were performed in a manner similar to Example 1, but at the shock cooling stage the fibers passed through the coolant bath 60 that was filled with a calcium oxide saturated solution at about 18° C.

### EXAMPLE 7

This example was run as a baseline to which the results of the other examples can be compared. In this example, all operations were performed in a manner similar to Example 1, but the preconditioning steps were not performed.

It can be seen from the foregoing that the preconditioning steps described herein significantly reduced fiber strength and hence, reduced the stress on the cutting assembly. For each of the Examples 1 through 6, the power utilized at the chopping station (row 2 in the Table) was reduced to less than half of that for Example 7 (in which no preconditioning was performed prior to the chopping operation). At the same time, each of the Examples 1 through 6 provided significantly improved production throughput rates as compared to the baseline Example 7.

Thus, the various preferred embodiments presented herein provide advantages over the prior art including reduced stress on the cutting assembly, reduced energy consumption, reduced wear, and increased reliability and productivity.

For purposes of the appended claims, the recited “first means” will be understood to correspond at least to the disclosed shock cooling stage and/or the fiber twisting stage as described herein, and will specifically exclude the various prior art techniques discussed in the background section above.

It is clear that the present invention is well adapted to carry out the objects and to attain the ends and advantages mentioned as well as those inherent therein. While presently preferred embodiments of the invention have been described for purposes of this disclosure, numerous changes may be made which will readily suggest themselves to those skilled in the art and which are encompassed within the spirit of the invention disclosed and as defined in the appended claims.

1. In a method of producing chopped fibers from rock materials which includes crushing rocks, passing the crushed rocks to a melting furnace, at least partially melting the crushed rocks to form a melt, homogenizing the melt, stabilizing the melt in a melting furnace feeder, drawing of the melt into heated fibers, and chopping the fibers into segments, the improvement comprising a step of preconditioning the heated fibers by shock cooling prior to the chopping step.

2. The improvement of claim 1, further comprising a step of twisting the fibers after the preconditioning step and prior to the chopping step.

3. The improvement of claim 1 in which the step of shock cooling the heated fibers comprises directing a stream of air against the heated fibers.

4. The method of claim 1 in which the step of shock cooling the heated fibers comprises contacting the heated fibers with a coolant liquid.

5. The method of claim 1 in which the step of shock cooling the heated fibers comprises contacting the heated fibers with steam.

6. The method of claim 1 in which the step of shock cooling the heated fibers comprises contacting the heated fibers with a vaporous surfactant.

7. The method of claim 6 wherein the surfactant is an alkali vapor.

8. A method for producing chopped rock fibers comprising steps of melting rocks, drawing the melted rocks into fibers, shock cooling the fibers, and chopping the fibers into segments.

9. The method of claim 8, wherein the rocks are characterized as basalt.

10. The method of claim 8, wherein the shock cooling step comprises passing the fibers through a stream of fluid to substantially reduce a temperature of the fibers.

11. The method of claim 8, wherein the shock cooling step comprises passing the fibers through a liquid coolant bath.

12. The method of claim 8, further comprising a step of twisting the fibers after the shock cooling step and prior to the chopping step.

13. An apparatus which carries out the method of claim 13.

14. An apparatus for producing chopped rock fibers comprising a furnace assembly configured to melt rocks, a drawing assembly configured to draw the melted rocks into fibers, and first means for inducing mechanical defects in the drawn fibers prior to chopping thereof.

15. The apparatus of claim 14, further comprising a chopping assembly which receives the drawn fibers from the first means and chops said fibers to selected lengths.

16. The apparatus of claim 14, wherein the first means comprises a shock cooling stage which significantly reduces a temperature of the drawn fibers.

17. The apparatus of claim 16, wherein the shock cooling stage comprises a nozzle which directs a stream of cooling fluid adjacent the drawn fibers.

18. The apparatus of claim 16, wherein the shock cooling stage comprises a liquid coolant bath through which the drawn fibers are passed.

19. The apparatus of claim 14, wherein the first means comprises a twisting assembly which induces a twisting of the drawn fibers.

20. The apparatus of claim 14, wherein the first means comprises a nozzle which directs a stream of fluid against the drawn fibers, a liquid coolant bath through which the drawn fibers pass, and a twisting assembly which induces a twisting of the fibers.
